(19) United States
(12) Patent Application Publication
(10) Pub. No.: US 2014/0006747 A1
(43) Pub. Date: Jan. 2, 2014

(54) SYSTEMS AND METHODS FOR PROCESSING INSTRUCTIONS WHEN UTILIZING AN EXTENDED TRANSLATION LOOK-ASIDE BUFFER HAVING A HYBRID MEMORY STRUCTURE

(71) Applicants: Wei-Hsiang CHEN, Sunnyvale, CA (US); Ricardo RAMIREZ, Sunnyvale, CA (US)

(72) Inventors: Wei-Hsiang CHEN, Sunnyvale, CA (US); Ricardo RAMIREZ, Sunnyvale, CA (US)

(73) Assignee: Broadcom Corporation, Irvine, CA (US)

(21) Appl. No.: 13/538,251

(22) Filed: Jun. 29, 2012

(51) Int. Cl. G06F 12/10

(52) U.S. Cl. 711/207; 711/E12.061

(57) ABSTRACT

An extended translation look-aside buffers (eTLB) for converting virtual addresses into physical addresses is described, which includes both a set associative memory structure (SAM) and a content addressable memory (CAM) structure. An improved approach for operating an eTLB is described in which the same instruction is issued to perform the same task regardless of the exact underlying memory structure within the eTLB being accessed. For flush operations, the same instruction to perform a TLB flush can be provided to the eTLB that operates upon both the CAM and the SAM, which is then handled differently by the underlying implementation system of the eTLB depending upon whether the CAM and/or SAM is being accessed.

### CROSS-REFERENCE TO RELATED APPLICATIONS

The present application is related to U.S. application Ser. No. 13/330,662, which is a continuation of U.S. application Ser. No. 12/859,013 filed on Aug. 18, 2010, which is a continuation of U.S. application Ser. No. 11/652,827 filed on Jan. 11, 2007, all of which are hereby incorporated by reference in their entireties for all purposes.

### BACKGROUND OF THE INVENTION

1. Field

The present disclosure relates generally to memory devices.

2. Background

In general, a translation look-aside buffer (TLB) is used to reduce virtual address translation time. A TLB is a table in the processor's memory that contains information about the pages in memory the processor has accessed recently. The table cross-references a program's virtual addresses with the corresponding absolute addresses in physical memory that the program has most recently used. A TLB enables faster computing because it caches the virtual to physical address translations locally. A TLB may be implemented in a number of ways. For example, a TLB may be enabled in a fully associative content addressable memory (CAM) structure. A CAM is a type of storage device which includes comparison logic with each bit of storage. A data value may be broadcast to all words of storage and then compared with the values there. Words matching a data value may be flagged in some way. Subsequent operations can then work on flagged words, e.g. read them out one at a time or write to certain bit positions in all of them. Fully associative structures can therefore store the data in any location within the CAM structure. Comparison logic, however, requires comparison circuitry, which occupies physical space—physical space which, in other structures may be utilized to provide more memory. As such, CAM structures may not be as densely configured as other memory structures. Further, because of the comparison circuitry, CAM structures have relatively high power requirements.

In other examples, a TLB may be enabled in a set associative memory (SAM) structure, such as a random access memory (RAM) structure. SAM structures organize caches so that each block of memory maps to a small number of sets or indexes. Each set may then include a number of ways. A data value may return an index whereupon comparison circuitry determines whether a match exists over the number of ways. As such, only a fraction of comparison circuitry is required to search the structure. Thus, SAM structures provide higher densities of memory per unit area as compared with CAM structures. Further, because of reduced comparison circuitry, SAM structures have lower power requirements as compared with CAM structures.

As may be appreciated, both of the memory structures described above may provide specific advantages in a processing system. In general, however, designers must typically choose between memory structures when developing a system under an existing architecture. For example, the Microprocessor without Interlocked Pipeline Stages (MIPS) architecture, which is well-known in the art, specifies a fully associative TLB based translation mechanism. The mechanism utilizes the EntryHi, EntryLo1, EntryLo0 and Index architectural registers to perform functions such as reading, writing and probing the TLB. These mechanisms and functions assume that the TLB is a fully associative structure (i.e. a CAM structure) that is in compliance with the requirements of the MIPS architecture. Therefore, increasing the size of the TLB necessitates the addition of more fully associative CAM structures. An increase in CAM structures, in turn, requires a commensurate increase in space and power to accommodate the additional CAM structures. Currently, the MIPS architecture cannot utilize a more space and power efficient SAM structure.

It may therefore be desirable to provide a system which includes an extended TLB (eTLB) that utilizes both CAM structures and SAM structures so that the relative advantages of both structures may be realized. The invention is particularly useful in systems that utilize existing registers and mechanism as specified by the MIPS architecture.

U.S. Pat. Nos. 7,797,509 and 8,082,416 disclose extended translation look-aside buffers (eTLB) for converting virtual addresses into physical addresses, in which the eTLB includes a physical memory address storage having a number of physical addresses, a virtual memory address storage configured to store a number of virtual memory addresses corresponding with the physical addresses, the virtual memory address storage including, a set associative memory structure (SAM), and a content addressable memory (CAM) structure; and comparison circuitry for determining whether a requested address is present in the virtual memory address storage, wherein the eTLB is configured to receive an index register for identifying the SAM structure and the CAM structure, and wherein the eTLB is configured to receive an entry register for providing a virtual page number corresponding with the plurality of virtual memory addresses.

With an eTLB structure having both a CAM and a SAM, there is a possibility that instructions will be issued to act upon entries in both (or either) the CAM and/or the SAM. For example, instructions may be issued to write entries to the eTLB, read entries from the eTLB, search for entries within the eTLB and/or flush entries from the eTLB. Despite the differences in the structures of the CAM and SAM mechanisms, it is nevertheless desirable for a system that implements the eTLB to efficiently process these instructions regardless of whether CAM entries or SAM entries are being processed.

### BRIEF SUMMARY OF THE INVENTION

The following presents a simplified summary of some embodiments in order to provide a basic understanding of the invention. This summary is not an extensive overview and is not intended to identify key/critical elements or to delineate the scope of the claims. Its sole purpose is to present some embodiments in a simplified form as a prelude to the more detailed description that is presented below.

According to some embodiments, a method is provided for operating an eTLB in which the same instruction is issued to perform the same task for both the CAM and the SAM. For example, the same instruction to perform a TLB flush can be provided to the eTLB that operates upon both the CAM and the SAM, which is handled differently by the underlying implementation system of the eTLB depending upon whether the CAM and/or SAM is being accessed. This approach allows instructions to be issued without the originator of the instruction being required to know the exact structure within the eTLB (either CAM or SAM) that is being accessed to implement the instruction.

As a result, it is possible to use the same instruction for operations on both the CAM and SAM. By way of example, a common usage of a TLB flush occurs when a CPU is performing context switching and needs to flush all of the TLB entries set up by the prior context. In accordance with an embodiment of the present invention, the TLB flush operation will look for any TLB entry with a particular application-specific identifier (ASID) for the prior context, and invalidate those entries.

Further details of aspects, objects, and advantages of various embodiments are described below in the detailed description, drawings, and claims. Both the foregoing general description and the following detailed description are exemplary and explanatory, and are not intended to be limiting as to the scope of the disclosure.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is an illustrative representation of an extended translation look-aside buffer (eTLB) architecture in accordance with embodiments of the present invention.

FIG. 2 is an illustrative representation of an index register in accordance with embodiments of the present invention.

FIG. 3 is an illustrative flowchart of an eTLB write index in accordance with embodiments of the present invention.

FIGS. 4A-B are illustrative flowcharts of an eTLB write random in accordance with embodiments of the present invention.

FIG. 5 is an illustrative flowchart of an eTLB read in accordance with embodiments of the present invention.

FIG. 6 is an illustrative flowchart of an eTLB probe in accordance with embodiments of the present invention.

FIGS. 7A-B are illustrative representations of a memory management unit (MMU) configuration register and an eTLB configuration register, in accordance with embodiments of the present invention.

FIG. 8 is an illustrative flowchart of utilizing an eTLB to translate a virtual address into a physical address or page frame number (PFN), in accordance with embodiments of the present invention.

FIG. 9 is an illustrative flowchart of utilizing an eTLB to process the same instruction for both a CAM and a SAM, in accordance with embodiments of the present invention.

FIG. 10 is an illustrative flowchart of utilizing an eTLB to process a flush instruction, in accordance with embodiments of the present invention.

FIG. 11 is an illustrative representation of an eTLB architecture using a state machine, in accordance with embodiments of the present invention.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

The disclosure will provide a description in detail with reference to a few embodiments thereof as illustrated in the accompanying drawings. In the following description, numerous specific details are set forth in order to provide a thorough understanding of the embodiments. It will be apparent, however, to one skilled in the art, that the present approach may be practiced without some or all of these specific details. In other instances, well known process steps and/or structures have not been described in detail in order to not unnecessarily obscure the present embodiments.

Various embodiments are described hereinbelow, including methods and techniques. It should be kept in mind that the approach might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments.

The present disclosure pertains to extended translation look-aside buffers (eTLB) for converting virtual addresses into physical addresses, in which the eTLB includes a physical memory address storage having a number of physical addresses, a virtual memory address storage configured to store a number of virtual memory addresses corresponding with the physical addresses, the virtual memory address storage including, a set associative memory structure (SAM), and a content addressable memory (CAM) structure; and comparison circuitry for determining whether a requested address is present in the virtual memory address storage, wherein the eTLB is configured to receive an index register for identifying the SAM structure and the CAM structure, and wherein the eTLB is configured to receive an entry register for providing a virtual page number corresponding with the plurality of virtual memory addresses.

According to some embodiments, a method is provided for operating an eTLB in which the same instruction is issued to perform the same task for both the CAM and the SAM. For example, the same write, read, search, or flush instruction can be provided to the eTLB that operates upon both the CAM and the SAM, which is handled differently by the underlying implementation system of the eTLB depending upon whether the CAM and/or SAM is being accessed. This approach allows instructions to be issued without the originator of the instruction being required to know the exact structure within the eTLB (either CAM or SAM) that is being accessed for the instruction.

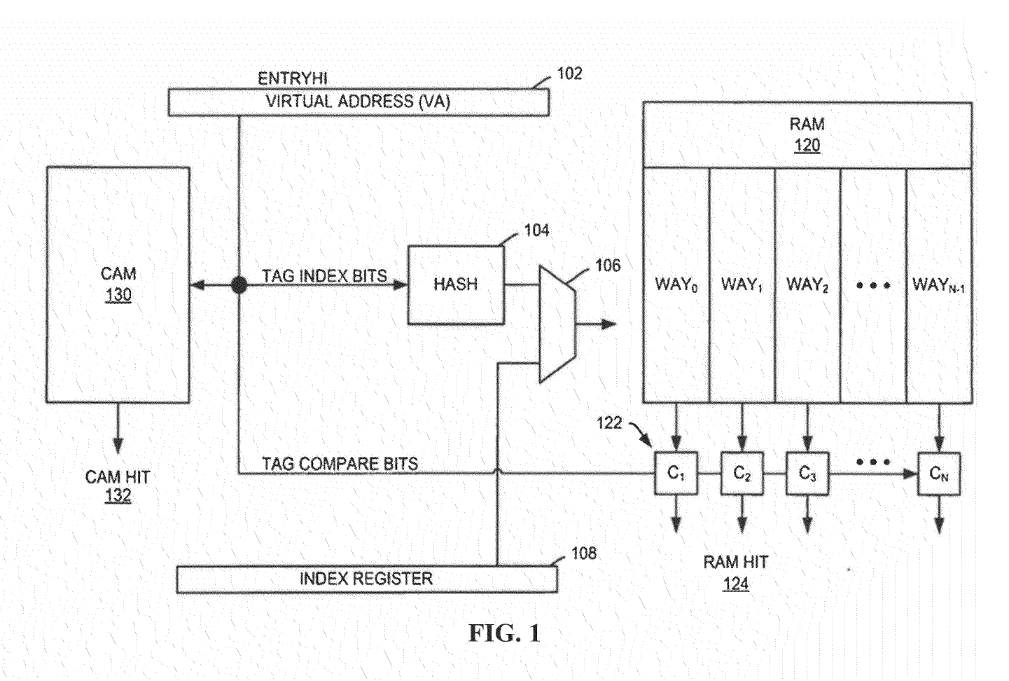

FIG. 1 is an illustrative representation of an extended translation look-aside buffer (eTLB) architecture in accordance with some embodiments. A conventional TLB, as noted above, typically utilizes either a content addressable memory structure (CAM) or a set associative memory (SAM) structure, but not both. In utilizing a hybrid system that incorporates a CAM structure and one or more SAM structures, embodiments of an eTLB may benefit from particular advantages provided by both structures at the same time.

Thus, CAM structure 130 provides a first memory structure for use with an eTLB in an embodiment of the present invention. As may be appreciated, CAM structures include comparison logic for each bit of storage. Comparison logic in turn requires comparison circuitry, which occupies physical space—physical space which, in other structures may be utilized to provide more memory. As such, CAM structures may not be as densely configured as other memory structures. Further, because of the comparison circuitry, CAM structures have relatively high power requirements. However, one benefit of a CAM structure is that searches conducted over a CAM structure happen simultaneously over all bits. Thus, a complete search of a CAM structure occurs over a single clock cycle. Another benefit of a CAM structure is that an address may reside in any entry in the CAM, therefore the CAM structure may be easily configured with a “wired” space, which is a protected memory space. This wired space can contain any address translation which the operating system wants to retain in the TLB. As may be appreciated, when a CAM structure is searched, a hit may occur. A CAM hit 132 results when a match with a virtual address (VA) 102 from an entry hi register occurs. A hit may result in a data retrieval from a data store. As may be appreciated, a ternary CAM (TCAM) may, in some embodiments, be utilized. A TCAM cell stores an extra state (i.e. a “don't care” state), which necessitates two independent bits of storage. When a “don't care” state is stored in the cell, a match occurs for that bit regardless of the search criteria.

SAM structure 120 provides a second memory structure for use with an eTLB in an embodiment of the present invention. SAM structures organize caches so that each block of memory maps to a small number of cache lines or indexes. Each index may then include a number of ways. Thus, an index register 108 may indicate a location across n-ways. In one embodiment, a 4-way set associative memory structure may be utilized. Comparison logic 122 compares the n-ways identified by index register 108 with tag compare bits from VA 102 and returns a SAM hit 124, if any. A hit may result in data retrieval from a data store. A SAM structure may be densely manufactured because only a fraction of comparison logic is utilized over a CAM structure having the same amount of memory. Additionally, because significantly less comparison logic is utilized, power requirements are also much lower over a similarly sized CAM structure. As may be appreciated, in a single SAM structure page size is not easily variable. In some embodiments, a SAM structure page size is set to 4 KB. Page size for a SAM structure may be programmatically established by setting a PageMask field of an eTLB configuration register to a desired page size in embodiments of the present invention. CAM structures, on the other hand, support variable page sizes and may include a wired or protected space. Thus, in one embodiment, a SAM structure page size of an eTLB is 4 KB and CAM page size is a variable page size greater than 4 KB. In some embodiments, a hash table 104 may be utilized to hash tag index bits from VA 102 for use with a SAM structure. In other embodiments, MUX 106 may be utilized when accessing SAM 120.

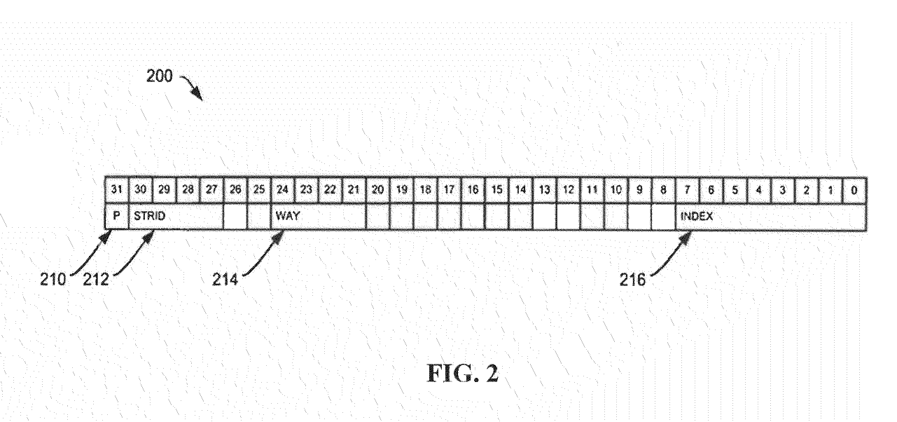

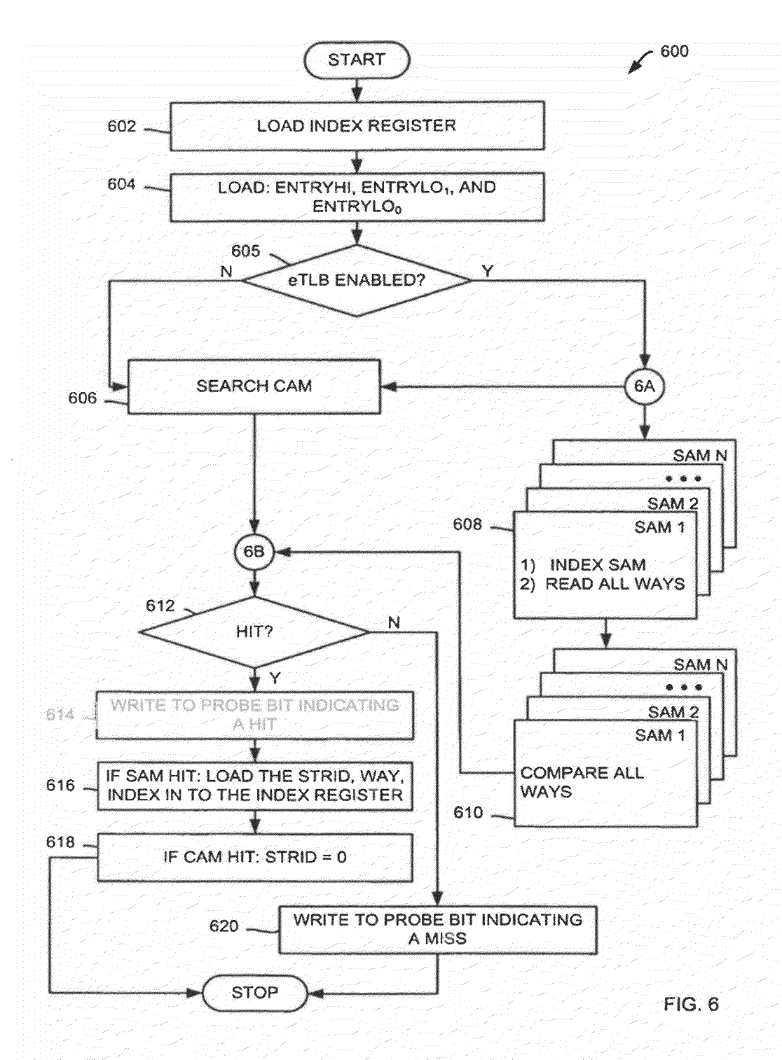

FIG. 2 is an illustrative representation of an index register 200 in accordance with embodiments of the present invention. Index register 200 may be utilized in coordination with an eTLB architecture for providing memory management functions. Index register 200 may include a probe bit 210 that may be utilized to indicate a match in response to an eTLB probe command. An eTLB probe command is discussed in further detail below for FIG. 6. Index register 200 may further include a structure ID (STRID) 212, which may be utilized to identify whether index register 200 corresponds with a CAM structure or with a SAM structure. In some embodiments, compatibility with legacy systems requires that the STRID of a CAM structure be equal to zero. Any number of structure IDs may be utilized without departing from the present invention. Index register 200 may further include way identifier (way ID) 214. Way ID 214 may be utilized to identify a way in a SAM structure. In some embodiments, SAM structures include: RAM, DRAM, SRAM, extended RAM, extended DRAM, extended SRAM, and a register file without departing from the present invention. Index register 200 may further include an index 216. Index 216 may include a VA corresponding with a CAM structure and a hashed index corresponding with a SAM structure.

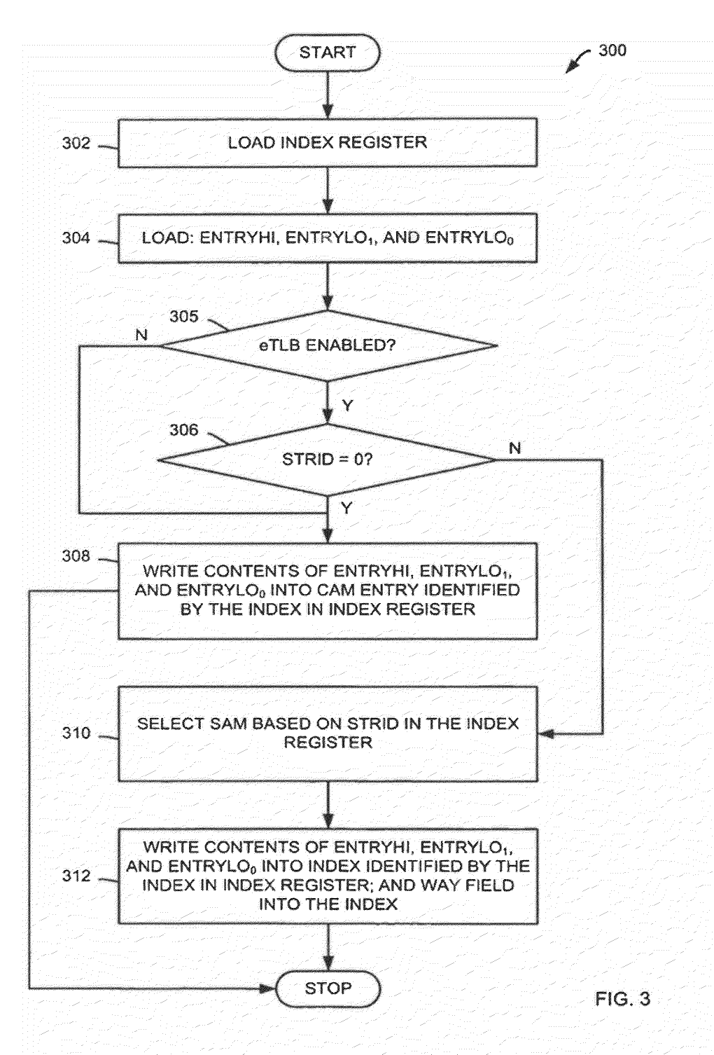

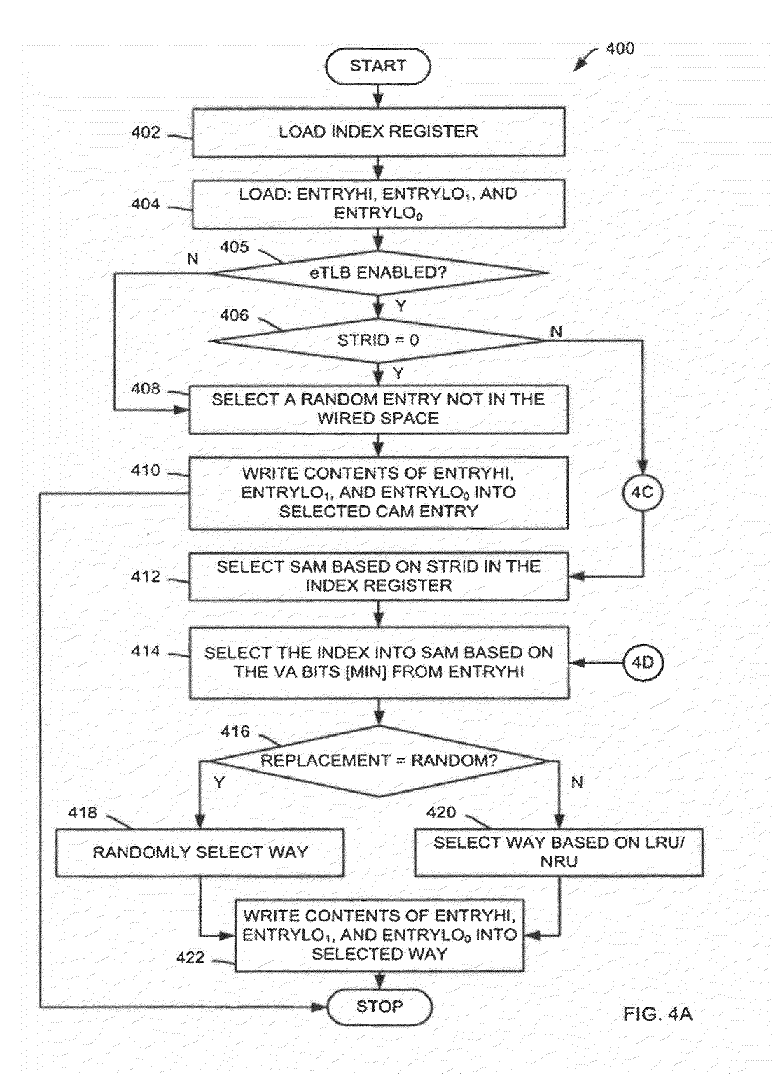

FIG. 3 is an illustrative flowchart of an eTLB write index 300 in accordance with embodiments of the present invention. An eTLB write index command loads an index register with an index, a way ID if applicable, and a structure ID. Thus, at a first step 302, an index register is loaded into memory. In addition to the physical page or frame number, each entry of the TLB contains attributes of the page. By way of non-limiting example, this information may be written into entryhi, entrylo₀, and entrylo₁ registers, although one skilled in the relevant arts will appreciate that other registers in this and other architectures may be utilized. At a next step 304, entryhi, entrylo₀, and entrylo₁ are loaded into memory. The method then determines whether an eTLB has been enabled at a step 305. As may be appreciated, methods described herein may be utilized with several system configurations without departing from the present invention. Thus, in one embodiment of the present invention, methods are provided that access a TLB (non-enabled eTLB) utilizing a CAM structure. Accessing a TLB utilizing a CAM structure is specified by the MIPS architecture. If the method determines that an eTLB is not enabled at a step 305, the method continues to a step 308 to write the contents of entryhi, entrylo₀, and entrylo₁ into the CAM entry identified by the index, whereupon the method ends.

If the method determines that an eTLB is enabled at a step 305, the method continues to determine Whether a stricture ID (STRID) is non-zero at a step 306. In this step, the method determines to which memory structure an index or VA is written. If the method determines that the structure ID is zero at a step 306, then the structure corresponding with the index register loaded at a step 302 is a CAM structure. The method then writes the contents of entryhi, entrylo₀, and entrylo₁ into the CAM entry identified by the index, which is a VA at a step 308, whereupon the method ends. If the method determines that the structure ID is non-zero at a step 306, then the structure corresponding with the index register loaded at a step 302 is a SAM. The method then selects the SAM structure corresponding with the STRID from the loaded index register at a step 310. The method then writes the contents of entryhi, entrylo₀, and entrylo₁ into the SAM entry identified by the index, and the way ID into the index register at a step 312, whereupon the method ends.

In accordance with embodiments of the present invention, it is not necessary to specify a structure ID (STRID) in an implementation in order to select which SAMs are used for an operation, such as a write operation. By way of non-limiting example, a write operation may solely depend on a page size, with a SAM only holding translations for a single page size, with multiple SAMs used to support different page sizes. In accordance with a further example, a TLB write random operation can be implemented such that software does not need to specify a STRID, but the selection of the SAM is determined by the page size specified by the TLB write random operation. Alternatively, a TLB write index operation (which is a write operation that specifies a specific entry in the eTLB), or a TLB read operation, may specify the structure of the eTLB, including the number of SAMs and the number of “ways” for each SAM (i.e., n-way memory) in order to uniquely identify a specific entry, in accordance with a farther embodiment of the present invention.

In accordance with an embodiment of the present invention, TLB probe, TLB flush, and TLB look-up operations may not know the structure of the eTLB in order for a match to be found, so a STRID and “way” fields (specifying the number of ways for each SAM) are not needed for these instructions. Moreover, in accordance with an additional embodiment of the present invention, the STRID and way information can be incorporated into a single index number. If the eTLB is organized in such a way that TLB entries of all memories (e.g., CAM or SAM) occupy sequential entries, then the value of the index number can identify which memory is being accessed for a TLB read index or TLB write index operation, in accordance with a further embodiment of the present invention.

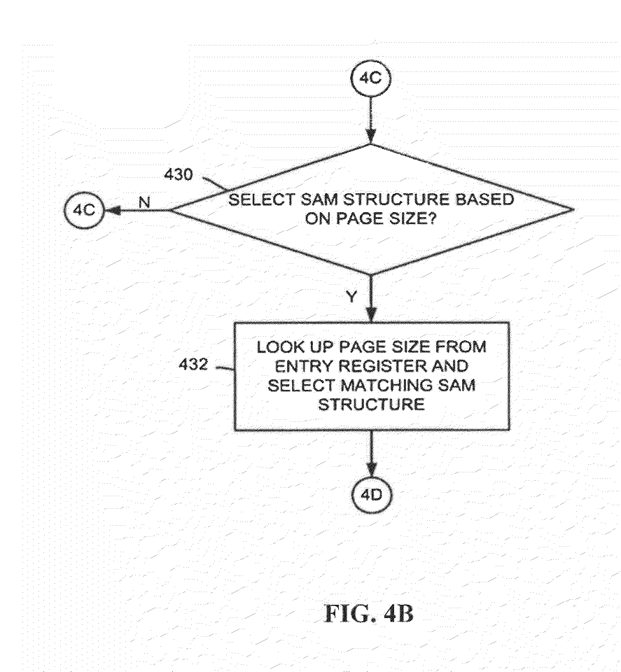

FIGS. 4A-B are illustrative flowcharts of an eTLB write random 400 in accordance with embodiments of the present invention. An eTLB write random command writes an entry corresponding with a hashed index. The determination of whether to write into a CAM structure or a SAM may, in some embodiments, be based on page size. For, example, in one embodiment, all 4K pages may be written into SAM while all other pages and wired pages may be written into CAM. Referring to FIG. 4A, at a first step 402, an index register is loaded. At a next step 404, entryhi, entrylo₀, and entrylo₁ are loaded. The method then determines whether an eTLB has been enabled at a step 405. As may be appreciated, methods described herein may be utilized with several system configurations without departing from the present invention. Thus, in one embodiment of the present invention, methods are provided that access a TLB (non-enabled eTLB) utilizing a CAM structure. Accessing a TLB utilizing a CAM structure is specified by the MIPS architecture.

If the method determines that an eTLB is not enabled at a step 405, the method continues to a step 408 to select a random entry in the CAM structure that is not in a wired space. As may be appreciated, a wired space represents protected memory. That is, memory that cannot be evicted from the TLB. The method then writes the contents of entryhi, entrylo₀, and entrylo₁ into the random CAM at a step 410, whereupon the method ends. If the method determines that an eTLB is enabled at a step 405, the method continues to determine whether a structure ID (STRID) is non-zero at a step 406. If the method determines that the structure ID is zero at a step 406, then the structure corresponding with the index register loaded at a step 402 is a CAM structure. The method then selects a random entry in the CAM structure that is not in a wired space at a step 408. As may be appreciated, a wired space represents protected memory. That is, memory that cannot be evicted from the eTLB. The method then writes the contents of entryhi, entrylo₀, and entrylo₁ into the random CAM at a step 410, whereupon the method ends.

If the method determines that the structure ID is non-zero at a step 406, then the structure corresponding with the index register loaded at a step 402 is a SAM structure. The method then selects a SAM structure corresponding with the STRID from the loaded index register at a step 412. The method then selects the index of the SAM based on the VA bits from the entryhi. The method then determines whether a random replacement is desired at a step 416. If the method determines at a step 416 that a random replacement is desired, the method selects a random way at a step 418. If the method determines at a step 416 that a random replacement is not desired, the method selects a way based on LRU or NRU at a step 420. The method then writes the contents of entryhi, entrylo₀, and entrylo₁ into the set associative entry identified by the index, and the way ID into the index register at a step 422, whereupon the method ends.

Referring to FIG. 4B, the flowchart illustrated represents optional steps for the described method in FIG. 4A. If the method determines that the structure ID is non-zero at a step 406, the method may optionally determine whether a SAM structure should be selected based on page size at a step 430. As noted above, some SAM structures, such as a RAM structure does not typically support variable pages within banks. Thus, a SAM structure may, in some embodiments, be selected based on page size. If the method determines at a step 430 to select a SAM structure based on page size, then the method looks up page sizes from an entry register and selects any matching SAM structures, whereupon the method continues to a step 414. If the method determines at a step 430 not to select a SAM structure based on page size, the method returns to a step 412.

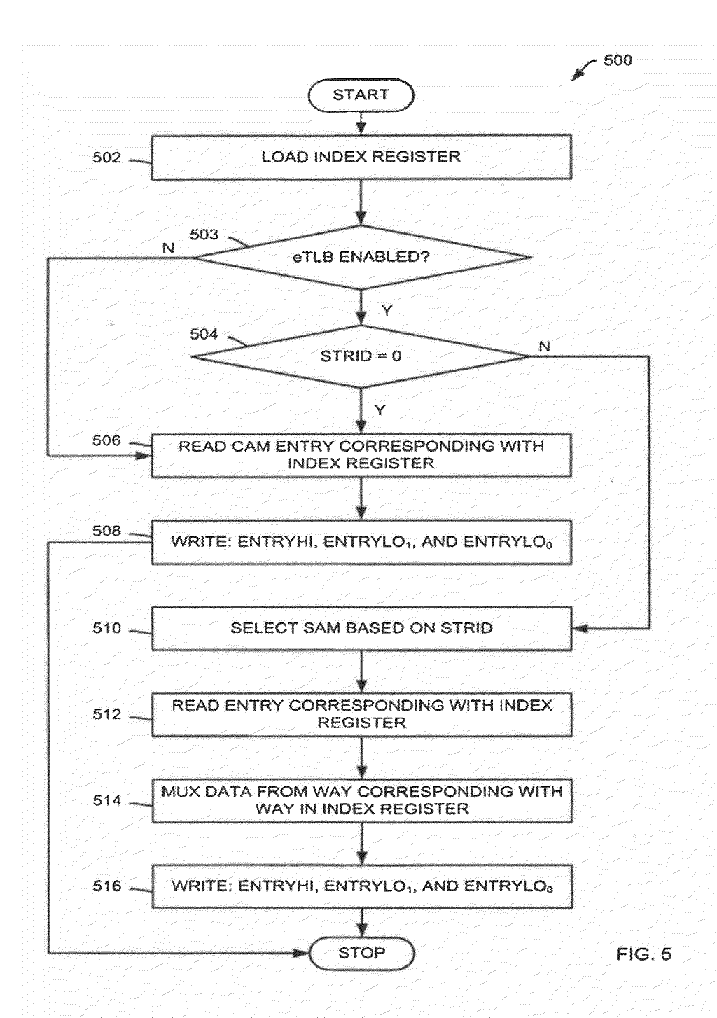

FIG. 5 is an illustrative flowchart of an eTLB read 500 in accordance with embodiments of the present invention. An eTLB read command utilizes an index register in embodiments of the present invention to read an entry. In addition, entryhi, entrylo0, and entrylo₁ are updated with the contents of the data storage. Thus, at a first step 502, an index register is loaded. The method then determines whether an eTLB has been enabled at a step 503. As may be appreciated, methods described herein may be utilized with several system configurations without departing from the present invention. Thus, in one embodiment of the present invention, methods are provided that access a TLB (non-enabled eTLB) utilizing a CAM structure. Accessing a TLB utilizing a CAM structure is specified by the MIPS architecture. If the method determines at a step 503 that an eTLB is not enabled, the method continues at a step 506, to read the CAM entry corresponding with the index register loaded at a step 502. The method then updates the entryhi, entrylo0, and entrylo1 with the contents of the data storage at a step 508, whereupon the method ends.

If the method determines that an eTLB is enabled at a step 503, the method then determines whether a structure ID (STRID) is non-zero at a step 504. If the method determines that the structure ID is zero at a step 504, then the structure corresponding with the index register loaded at a step 502 is a CAM structure. The method continues at a step 506, to read the CAM entry corresponding with the index register loaded at a step 502. The method then updates the entryhi, entrylo0, and entrylo₁ with the contents of the data storage at a step 508, whereupon the method ends. If the method determines at a step 504 that the structure ID is non-zero, then the structure corresponding with the index register loaded at a step 502 is a SAM structure. The method then selects at a step 510, the SAM structure corresponding with the STRID in the loaded index register at a step 502. The method continues at a step 512, to read the entry corresponding with the index register loaded at a step 502. Data from the way corresponding with the index register is MUXed at a step 514. MUXing data is well-known in the art and may be utilized without limitation without departing from the present invention. The method then updates the entryhi, entrylo0, and entrylo₁ with the contents of the data storage at a step 516, whereupon the method ends.

FIG. 6 is an illustrative flowchart of an eTLB probe 600 in accordance with embodiments of the present invention. eTLB probes all associated memory structures for a match with a requested address. Both SAM and CAM may be probed simultaneously, substantially simultaneously, or sequentially as desired without departing from the present invention. Thus, at a first step 602, an index register is loaded into memory. At a next step 604, entryhi, entrylo₀, and entrylo₁ are loaded into memory. The method then determines whether an eTLB has been enabled at a step 605. As may be appreciated, methods described herein may be utilized with several system configurations without departing from the present invention. Thus, in one embodiment of the present invention, methods are provided that access a TLB (non-enabled eTLB) utilizing a CAM structure. Accessing a TLB utilizing a CAM structure is specified by the MIPS architecture. If the method determines at a step 605 that an eTLB is not enabled, the method continues to a step 606 to search the CAM using a VA from the entryhi as a search key. The method then continues to a step 612 to determine whether a hit has occurred. If no hit occurs at a step 612, the method continues to a step 620 to write to the probe bit to indicate a miss whereupon the method ends. If the method determines a hit (or match) has occurred at a step 612, the method continues to a step 614 to write a zero in the probe failure bit to indicate a hit. A probe bit is illustrated in FIG. 2, 210 above. If a CAM has produced a hit, then, at a step 618, the structure ID is set to zero.

If the method determines at a step 605 that an eTLB is enabled, the method continues to a step 606, to search the CAM using a VA from the entryhi as a search key. The method substantially simultaneously continues to a step 608 to 1) Use a subset of the VA bits [m:n] to index the SAM, and 2) Read all indexed ways. The upper bits of the VA [MSB; m+1] are then compared with all the indexed ways at a step 610. As may be appreciated, any number of SAM structure banks may be searched without departing from the present invention. Thus, SAM structures 1 to n may be searched at steps 608 to 610. The method continues to a step 612 to determine whether a hit has occurred. If no hit (i.e. no match) occurs at a step 612, the method continues to a step 620 to write to a probe bit to indicate a “miss” whereupon the method ends. If the method determines a hit (or match) has occurred at a step 612, the method continues to a step 614 to write a zero in a probe bit to indicate a “hit.” A probe bit is illustrated in FIG. 2, 210 above. If a SAM structure has produced a hit, then at a step 616, the structure ID of the SAM structure, the “hit” way, and the index are loaded into an index register. If a CAM structure has produced a hit, then at a step 618, the structure ID is set to zero.

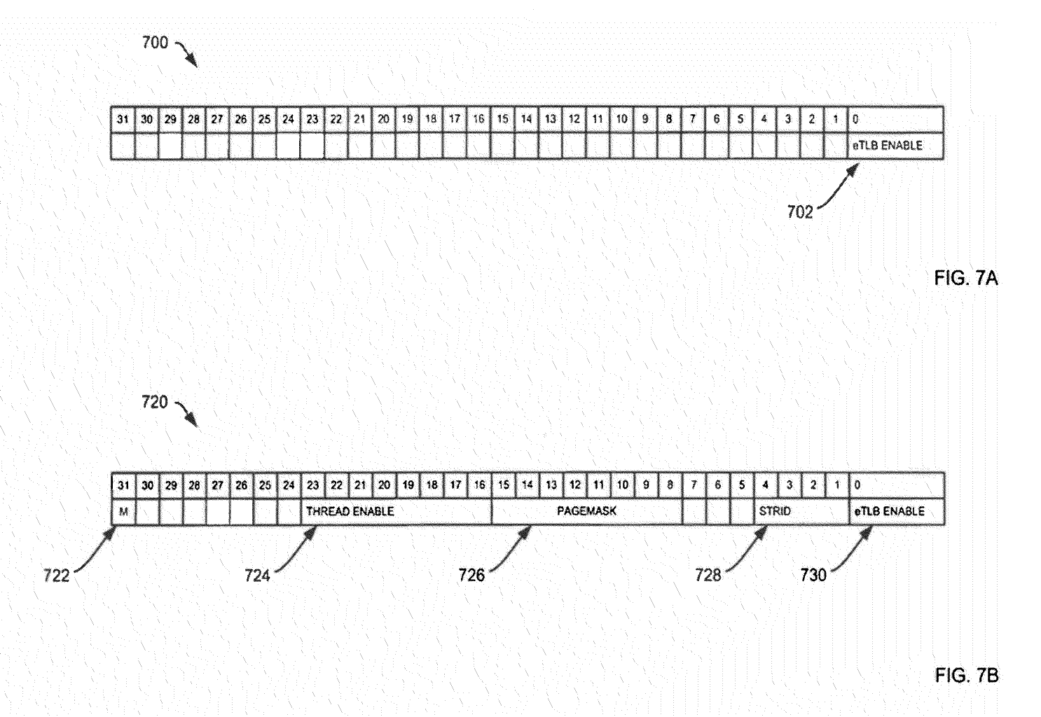

FIG. 7A is an illustrative representation of a memory management unit (MMU) configuration register 700 in accordance with embodiments of the present invention. As discussed above, methods disclosed herein provide for utilization of both CAM structures and SAM structures. In some embodiments, a number of configuration registers may be required for associated hardware such as an MMU, for example. An MMU is a class of computer hardware components responsible for handling memory accesses requested by a CPU. Among the functions of such devices are the translation of virtual addresses to physical addresses virtual memory management), memory protection, cache control, bus arbitration, and, in simpler computer architectures (especially 8-bit systems), bank switching. Thus, an MMU utilizing embodiments herein may be configured with an MMU configuration register 700, which contains an eTLB enable field 702 that enables eTLB features such as those described herein. As may be appreciated, the representation provided is for illustrative purposes only and should not be construed as limiting. Any available bits in a configuration register may be utilized to enable eTLB features without departing from the present invention. Furthermore, any manner of configuring an MMU that is well-known in the art may be utilized without departing from the present invention.

FIG. 7B is an illustrative representation of an eTLB configuration register 720 in accordance with embodiments of the present invention. An eTLB configuration register 700 may be utilized to enable the use of SAM structures. As such, eTLB configuration register 700 contains a number of fields for enabling the use of SAM structures. A PageMask field 726 may be utilized to determine a page size supported by a particular SAM structure. In one embodiment a PageMask field for a SAM structure may determine a 4K page size. A structure ID (STRID) field 728 may be utilized to identify a particular SAM structure. As may be appreciated, any number of SAM structures may be utilized in embodiment of the present invention. An M hit 722 may be utilized to indicate whether an additional eTLB configuration register exists for another SAM structure. An eTLB configuration register corresponds with a SAM structure in a one-to-one relationship. When multiple SAM structures are utilized, then a corresponding number of additional eTLB configuration registers are required. Additional eTLB configurations may be indicated by an M bit such as M bit 722 illustrated. In this manner, eTLB registers may be associated to specify the behavior of multiple SAM structures.

A thread enable field 724 may be enabled to indicate the threads whose translations will reside in a selected SAM structure. Thus, a configuration may include or exclude a particular thread on a selected SAM structure. In one embodiment, a single thread may be configured to access a single SAM structure. In another embodiment, a single thread may be configured to access multiple SAM structures. In another embodiment, multiple threads may be configured to access a single SAM structure. In another embodiment, multiple threads may be configured to access several SAM structures. An eTLB enable field 730 may be utilized to indicate whether eTLB functionality is enabled for a particular memory structure. As may be appreciated, the representation provided is for illustrative purposes only and should not be construed as limiting. Any available bits in a configuration register may be utilized to enable eTLB features without departing from the present invention.

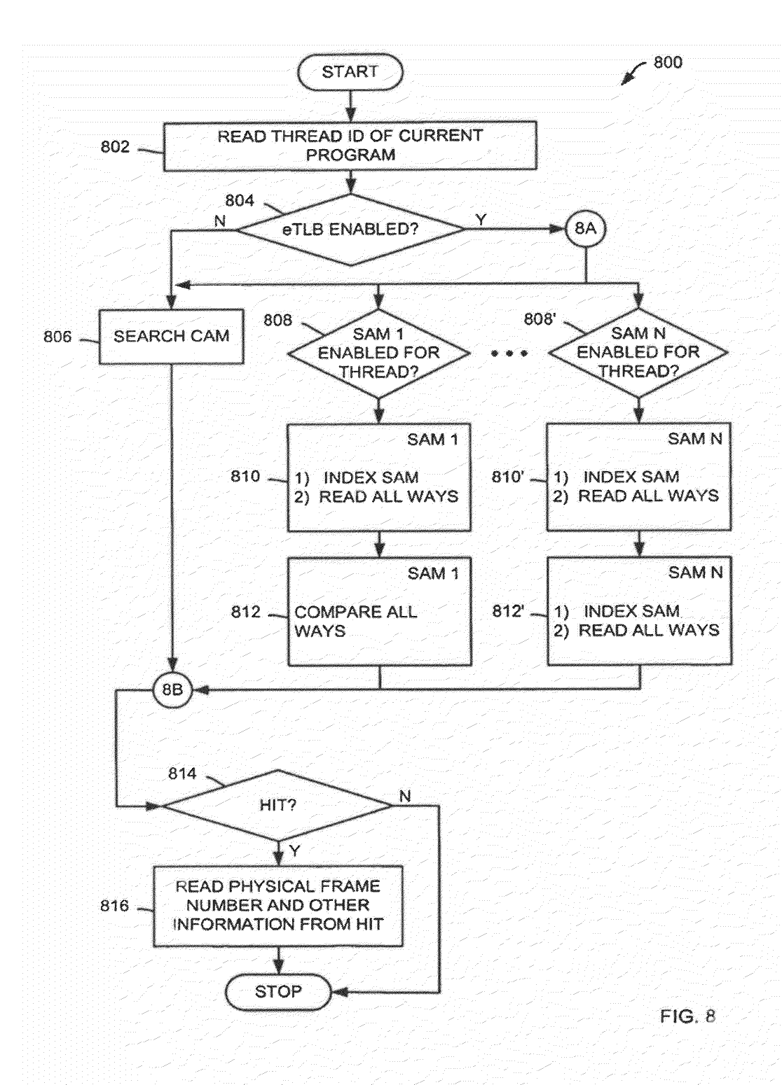

FIG. 8 is an illustrative flowchart 800 of utilizing an eTLB to translate a virtual address into a physical address or page frame number (PFN). At a first step 802, the method reads a thread ID of a current program. As noted above, threads may be configured to access memory structures in various ways without departing from the present invention. The method then determines whether an eTLB has been enabled at a step 804. As may be appreciated, methods described herein may be utilized with several system configurations without departing from the present invention. Thus, in one embodiment of the present invention, methods are provided that access a TLB (non-enabled eTLB) utilizing a CAM structure. Accessing a TLB utilizing a CAM structure is specified by the MIPS architecture. If the method determines at a step 804 that an eTLB is not enabled, the method continues to a step 806 to search the CAM using a VA from execution of the memory operation as a search key. The method then continues to a step 814 to determine whether a hit has occurred. If no hit occurs at a step 814, the method ends. If the method determines a hit (or match) has occurred at a step 814, the method continues to a step 816 to read a physical frame number (PFN) corresponding with a “hit” VA along with other information relevant to the “hit.”

If the method determines at a step 804 that an eTLB is enabled, the method continues to a step 806, to search the CAM using a VA from execution of the memory operation a search key. The method substantially simultaneously continues to a step 808 to 1) Use a subset of the VA bits [m:n] to index the SAM, and 2) Read all indexed ways. The upper bits of the VA [MSB; m+1] are then compared with all the indexed ways at a step 810. As may be appreciated, any number of SAM structure banks may be searched without departing from the present invention. Thus, SAM structures 1 to n may be searched at steps 808/808′ to 812/812′. The method then continues to a step 814 to determine whether a hit has occurred. If no hit occurs at a step 814, the method ends. If the method determines a hit (or match) has occurred at a step 814, the method continues to a step 816 to read a physical frame number (PFN) corresponding with a “hit” VA along with other information relevant to the “hit.” As may be appreciated, a PFN corresponds with a physical address residing in memory. In this manner, a VA is translated to a PFN.

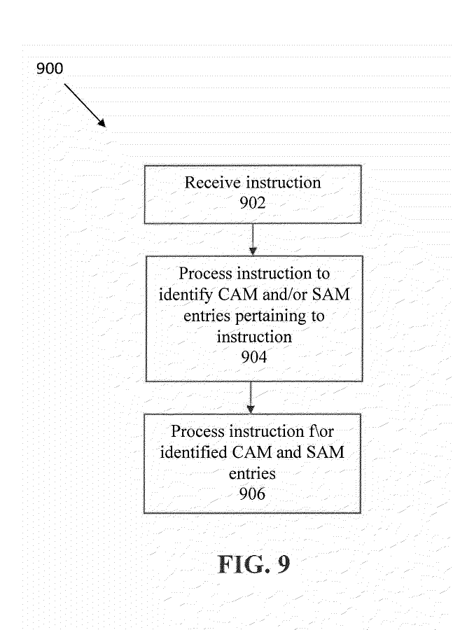

FIG. 9 is an illustrative flowchart 900 of an approach for handling an instruction at an eTLB that includes both a CAM and a SAM. At 902, an instruction is received to perform a task at an eTLB. The same instruction is provided regardless of the type of memory within the eTLB that is to be operated upon by the task. The originator of the instruction will not need to be aware of the specific type of memory (e.g., CAM or SAM) within the eTLB that is to be accessed. Instead, the originator of the instruction will be able to provide a common instruction that works with any type of underlying memory structure within the eTLB, and will not be required to provide a CAM-specific or SAM-specific instruction for the eTLB access.

For example, an instruction may be received to perform an eTLB write index (e.g., as described in FIG. 3), where the same instruction is received regardless of whether task to be completed by the instruction is to be directed to a CAM or a SAM. Similarly, an instruction may be received to perform an eTLB write random (e.g., as described in FIGS. 4A-B), where the same instruction is provided with respect to the same write random task without regard for whether the task is to be directed to an entry in the CAM or a SAM. As yet another example, an instruction may be received to perform an eTLB probe (e.g., as described in FIG. 5), where the same probe instruction is provided with respect to the same task regardless of whether the task is to be directed to the CAM or a SAM.

At 902, the instruction is processed to identify the portions of the eTLB content that needs to be operated upon by the instruction. Even though a common instruction is being provided, the actual processing of the instruction will need to understand which underlying type of memory stricture is being accessed to process the instruction.

For example, if an instruction is received to perform an eTLB probe (e.g., as described in FIG. 5), then a check is made whether the eTLB is enabled (e.g., by step 605) to determine whether the CAM and/or SAM structures will be probed. Similarly, if an instruction is received to perform an eTLB write index (e.g., as described in FIG. 3), a check is made whether the eTLB is enabled (e.g., by step 305) to determine whether the CAM entry and/or the SAM entry needs to be processed. If an instruction is received to perform an eTLB write random (e.g., as described in FIGS. 4A-B), then a check is made (e.g., by step 405) to determine whether the write operation is to be performed in a CAM entry and/or SAM entry.

Next, at 906, processing is performed to implement the task described by the instruction. Even though a common instruction was provided without regard for the underlying TLB memory structure, the actual processing of the instruction may differ depending upon whether the instruction is directed to a CAM entry or a SAM entry.

For example, if an instruction is received to perform an eTLB probe (e.g., as described in FIG. 5), then a CAM search (as described for step 606) is performed for CAM entries and SAM search processing (as described for steps 608-610) is performed for SAM entries. Similarly, if an instruction is received to perform an eTLB write index (e.g., as described in FIG. 3), then the processing path starting with step 308 is performed for a CAM entry and the processing path from step 310 is performed for a SAM entry. If an instruction is received to perform an eTLB write random (e.g., as described in FIGS. 4A-B), then the processing path starting with step 408 is performed for a CAM entry and the processing path from step 412 is performed for a SAM entry.

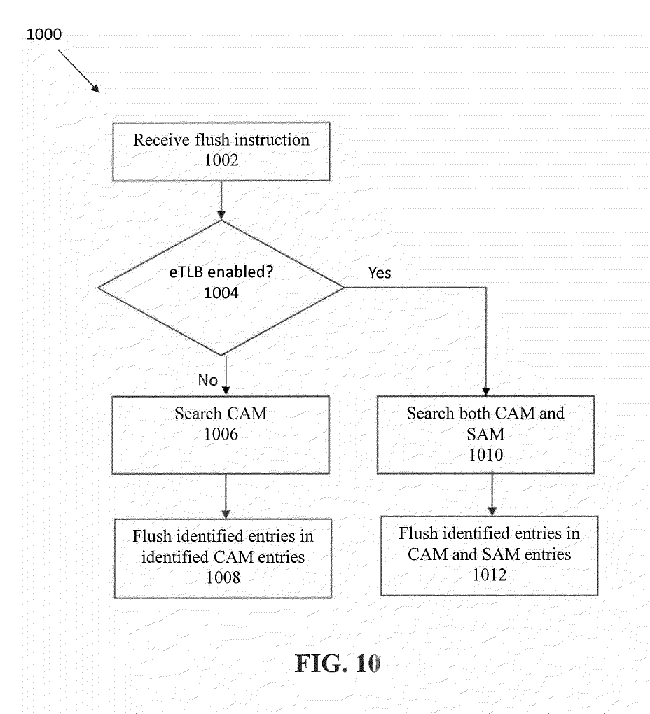

FIG. 10 is an illustrative flowchart 1000 of an approach for performing a flush of TLB entries, when operating with an eTLB that includes both a CAM and a SAM. There are many uses for this type of flush operation. For example, each TLB entry (particularly in a MIPS implementation) is tagged with an ASID (application specific ID). The use of an ASID is provided by way of example, and not limitation, and an alternative identification mechanism is contemplated within the scope of this disclosure to allow multiple virtual address spaces to be used. It is possible that ASID values are recycled and re-used by the processing system. In this situation, the entries in the TLB that correspond to the now-invalid ASID values will need to be flushed.

At 1002, an instruction is received to perform flush the TLB. The same instruction is provided regardless of whether the flush operation is to be performed against the CAM or the SAM in the eTLB. The originator of the instruction will not need to be aware of the specific type of memory (e.g., CAM or SAM) within the eTLB that is to be accessed to flush the entries. Instead, the originator of the instruction will be able to provide a common instruction that works with any type of underlying memory structure within the eTLB, and will not be required to provide a CAM-specific or SAM-specific instruction to flush the eTLB.

One reason this is advantageous is because the typical set of operations needed to flush a SAM are different from (and much more elaborate than) the operations needed to a flush a CAM. With CAM structures, a complete search (and clear) can be performed simultaneously over all of the entries within the CAM. In contrast, a SAM structure (e.g., as shown in FIG. 1) with the multiple (e.g., four) separate comparison logic would require multiple separate operations to first probe the memory to identify the entries to invalidate, and then separate operations to invalidate the identified entries. Without the present approach, the originator of the flush instruction would need to know upfront which type of memory structure is being accessed, and would then need to structure the flush instructions differently depending upon whether CAM entries or SAM entries are being flushed, i.e., would need to otherwise format the flush instructions for the SAM entries as multiple separate probe and invalidation instructions. Using the present embodiment, the same single instruction is provided to flush the TLB entries, without regard for whether the underlying structure is a CAM or a SAM. This provides significant performance and efficiency improvement, since the instruction count is reduced to a single instruction regardless of the type of the TLB entry that is being flushed.

At 1002, a determination is made whether an eTLB has been enabled. As may be appreciated, methods described herein may be utilized with several system configurations without departing from the present invention. Thus, in one embodiment of the present invention, methods are provided that access a TLB (non-enabled eTLB) utilizing a. CAM structure. If an eTLB is not enabled, the method continues to a step 1006 to search the CAM for the required entries and to then invalidate those CAM entries at 1008.

If it is determined that an eTLB has been enabled, the method continues to 1010 to search the CAM and/or SAM for the entries to be invalidated. The input for a flush instruction typically includes one or more virtual address(es) and ASID value(s). The values are used as the search keys to search the CAM and SAM structures for matching entries. One possible approach to perform this type of search is described above with respect to FIG. 6.

At 1012, the identified entries in the CAM and/or SAM are invalidated. In some embodiments, eTLB entries can be invalidated by simply performing an operation to over-write a page's entry with an invalid value.

As discussed above, the search and invalidation of the CAM can actually be performed with a single clock cycle, and therefore does not need to be broken into separate steps as shown. In contrast, the search and invalidation of the SAM structure may correspond to multiple separate operations, depending upon the exact structure of the SAM and the number of comparison logic mechanisms implemented within the SAM.

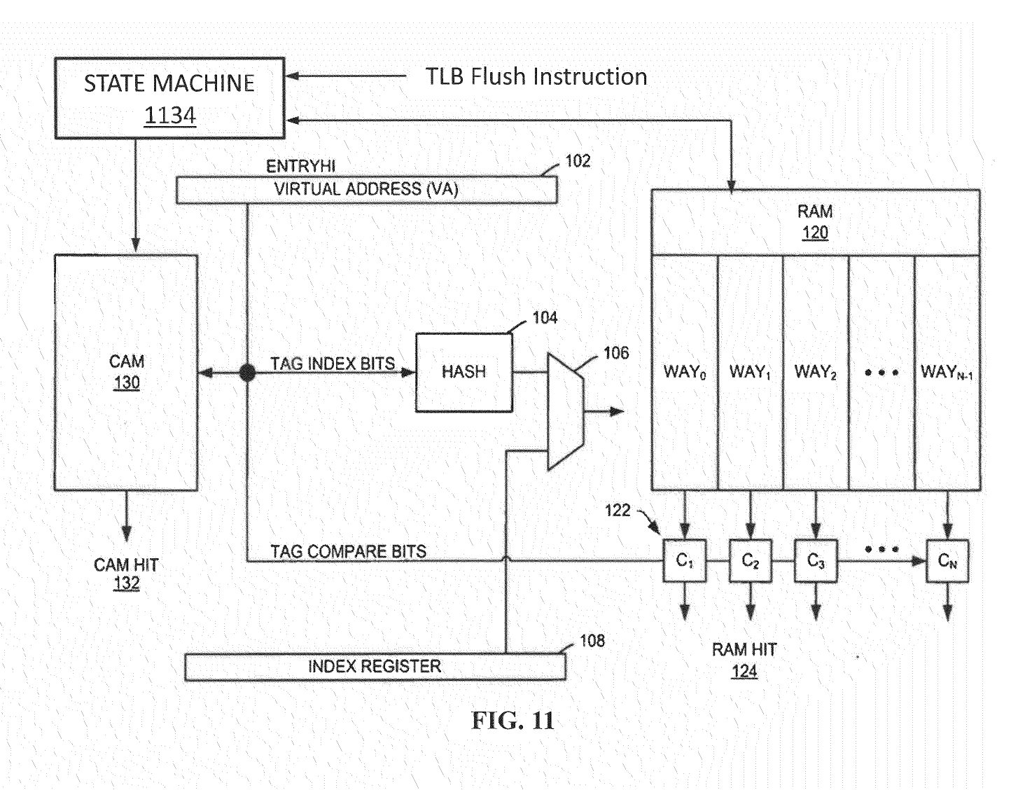

The operations of flowchart 1000 of FIG. 10 can be implemented in a state machine in the eTLB architecture. FIG. 11 is an illustrative representation of an eTLB architecture using a state machine, in accordance with embodiments of the present invention. FIG. 11 follows closely from FIG. 1, but includes state machine 1134. State machine 1134 is configured to receive the TLB flush instruction. For a non-extended. TLB implementation (i.e., eTLB has not been enabled, as determined at step 1004 of FIG. 10), the flush instruction is sent to CAM 130 as in steps 1006 and 1008 of FIG. 10. For an extended TLB implementation (i.e., eTLB has been enabled, as determined at step 1004 of FIG. 10), the virtual address is sent to both the CAM 130 and RAM 120. The output of the RAM search (as in step 1010 of FIG. 10) can then be fed back to state machine 1134, and memory entries found by search are flushed, in accordance with an embodiment of the present invention.

Therefore, what has been described is an improved approach for operating an eTLB in which the same instruction is issued to perform the same task regardless of the exact underlying memory structure within the eTLB being accessed. For flush operations, the same instruction to perform a TLB flush can be provided to the eTLB that operates upon both the CAM and the SAM, which is then handled differently by the underlying implementation system of the eTLB depending upon whether the CAM and/or SAM is being accessed. This approach allows instructions to be issued without the originator of the instruction being required to know the exact structure within the eTLB (either CAM or SAM) that is being accessed to implement the instruction.

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for utilizing a memory structure, comprising,
providing a common instruction to perform a task that is directed to an extended translation look-aside buffer (eTLB) for converting a virtual address into a physical address, wherein the eTLB comprises a set associative memory (SAM) structure and a content addressable memory (CAM) structure, in which both the SAM structure and the CAM structure are operable to hold entries for address translation; and
using the common instruction to perform the task on the entries in either the CAM structure or the SAM structure.

2. The method of claim 1, in which the common instruction comprises a flush instruction.

3. The method of claim 2, in which the flush instruction includes instruction data having both the virtual address and an application specific ID.

4. The method of claim 2, in which the flush instruction is converted into underlying operations that are different for the CAM structure as compared to the SAM structure.

5. The method of claim 4, in which the underlying operations for the SAM structure comprises probe operations and invalidation operations.

6. The method of claim 1, in which the common instruction comprises an instruction to write an entry, read an entry, or probe for the entries.

7. The method of claim 1, in which the CAM structure and the SAM structure are processed simultaneously, substantially simultaneously, or sequentially.

8. An apparatus having an extended translation look-aside buffer (eTLB) for converting a virtual address into a physical address, the eTLB comprising,
a set associative memory (SAM) structure, and
a content addressable memory (CAM) structure, in which both the SAM structure and the CAm structure are operable to hold entries for address translation, and wherein a common instruction to perform a task is applicable to perform the task on the entries in either the CAM structure or the SAM structure.

9. The apparatus of claim 8, in which the common instruction comprises a flush instruction.

10. The apparatus of claim 9, in which the flush instruction includes instruction data having both the virtual address and an application specific ID.

11. The apparatus of claim 9, in which the flush instruction is converted into underlying operations that are different for the CAM structure as compared to the SAM structure.

12. The apparatus of claim 11, in which the underlying operations for the SAM structure comprises probe operations and invalidation operations.

13. The apparatus of claim 8, in which the common instruction comprises an instruction to write an entry, read an entry, or probe for the entries.

14. The apparatus of claim 8, in which the CAM structure and the SAM structure are processed simultaneously, substantially simultaneously, or sequentially.

15. A non-transitory computer readable medium having stored thereon a sequence of instructions which, when executed by a processor, causes said processor to execute a process for utilizing a memory, the process comprising:
providing a common instruction to perform a task that is directed to an extended translation look-aside buffer (eTLB) for converting a virtual address into a physical address, wherein the eTLB comprises a set associative memory (SAM) structure and a content addressable memory (CAM) structure, in which both the SAM structure and the CAM structure are operable to hold entries for address translation; and
using the common instruction to perform the task on the entries in either the CAM structure or the SAM structure.

16. The medium of claim 15, in which the common instruction comprises a flush instruction.

17. The medium of claim 16, in which the flush instruction includes instruction data having both the virtual address and an application specific ID.

18. The medium of claim 16, in which the flush instruction is converted into underlying operations that are different for the CAM structure as compared to the SAM structure.

19. The medium of claim 18, in which the underlying operations for the SAM structure comprises probe operations and invalidation operations.

20. The medium of claim 15, in which the common instruction comprises an instruction to write an entry, read an entry, or probe for the entries.

21. The medium of claim 15, in which the CAM structure and the SAM structure are processed simultaneously, substantially simultaneously, or sequentially.
